(19) United States
(12) Patent Application Publication
(10) Pub. No.: US 2024/0288355 A1
(43) Pub. Date: Aug. 29, 2024

(54) CALIBRATION OBJECT FOR CALIBRATING AN IMAGING SYSTEM

(71) Applicant: LEICA MICROSYSTEMS CMS GMBH, Wetzlar (DE)

(72) Inventor: Soeren ALSHEIMER, Wetzlar (DE)

(21) Appl. No.: 18/572,875

(22) PCT Filed: Jun. 24, 2021
(86) PCT No.: PCT/EP2021/067377

§ 371 Date: Dec. 21, 2023

(51) Int. Cl. G01N 15/10; G01N 15/14; G02B 21/00

(52) U.S. Cl. CPC G01N 15/1012; G01N 15/14; G01N 15/1459; G02B 21/0076; G02B 21/008; G01N 2015/1014; G01N 2015/1493

(57) ABSTRACT

A calibration object for calibrating an imaging system includes a discrete entity with a calibration pattern. The discrete entity is made of at least one transparent polymeric compound.

### CROSS REFERENCE TO RELATED APPLICATIONS

This application is a U.S. National Phase application under 35 U.S.C. § 371 of International Application No. PCT/EP2021/067377, filed on Jun. 24, 2021. The International Application was published in English on Dec. 29, 2022 as WO 2022/268325 A1 under PCT Article 21(2).

### FIELD

Embodiments of the invention relate to a calibration object for calibrating an imaging system. The calibration object comprises a discrete entity made of a transparent polymer and with a calibration pattern. A further aspect is a method for calibrating an imaging system by means of the calibration object and a method for manufacturing the calibration object.

### BACKGROUND

In cytometry biological sample, typically suspensions of cells, which are labelled with fluorescent markers are fed through a flow cell, in which they are excited by a laser beam and their emission light is detected by one or more photomultipliers. Present day cytometers can in this way process a high number of cells and analyse them for the expression of multiple markers at a time. The readout of these devices provides intensity values that are assigned to a particular cell or event. In addition to the intensity values of fluorescence markers modern cytometers also allow the gating of cell populations based on scattered light using forward, back, and side scatter.

A smaller segment of cytometry is imaging flow cytometry, in which a camera is used as a detector generating an image of the events passing through the flow cell. For example, document U.S. Pat. No. 7,634,126 B2 discloses an imaging flow cytometer for collecting multispectral images of a population of cells. Further, the document EP 0 501 008 B1 provides an imaging flow cytometer configured to simultaneously capture a white light image and a fluorescent image of a cell in a flow cell.

The image quality obtained with this approach is however significantly lower as compared to the image quality obtained with standard microscopes, which is largely due to various technical challenges that arise from imaging an object in a flow cell and in flow.

Recently, STEAM cameras have been used to acquire brightfield images of cells at high-speed in imaging flow cytometers. While this technology has led to significant improvements in image quality and is capable of imaging up to 100,000 cells per second and at the same time shortening the exposure time per cell significantly. Light-sheet fluorescence imaging flow cytometry is a comparably new and promising branch of imaging flow cytometry, which is based on the combination of light-sheet fluorescence microscopy with imaging samples flowing through a flow cell. Various types of light sheet fluorescence microscopes have been proposed such as, selective plane of illumination (SPIM) microscopes as disclosed in WO 2004/053558 A1, lattice, Bessel, scanned light sheet or virtual light sheet microscopes.

Implementations of light-sheet imaging flow cytometers, typically require the orthogonal placement of illumination and detection optics, such that the light sheet illumination and the axis of detection are perpendicular to each other, which means that the plane of focus (detection) can be brought into coincidence with the plane of illumination. At the same time, light sheet imaging flow cytometers typically require the light sheet to cross the flow cell at an angle different from 0°, which allows the capture of Z-stacks by passing a sample through the light sheet. As a result of the illumination light sheet hitting the flow cell window at an angle different from 0° numerous aberrations including spherical, chromatic aberration and coma are caused.

Free-form optics or Alvarez plates (wave front manipulators) may be used to correct these aberrations, as described in WO 2019/063539 A1. However, the manufacturing of free-form optics is a complicated and expensive process.

### SUMMARY

Embodiments of the present invention provide a calibration object for calibrating an imaging system. The calibration object includes a discrete entity with a calibration pattern. The discrete entity is made of at least one transparent polymeric compound.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic view of a hydrogel bead according to some embodiments;

FIG. 2 shows a further embodiment of a hydrogel bead;

FIG. 3 shows a schematic view of a microfluidic device for forming hydrogel beads according to FIG. 1, according to some embodiments;

FIG. 4 shows a schematic view of a further embodiment of a microfluidic device for forming hydrogel beads according to FIG. 2;

FIG. 5 shows further embodiments of hydrogel beads with calibration patterns;

FIG. 6 shows a schematic view of a lithographic device for generating calibration patterns continuously according to some embodiments;

FIG. 7 shows a schematic view of a lithographic device for generating calibration patterns in batch according to some embodiments;

FIG. 8 shows further embodiments of hydrogel beads with calibration patterns;

FIG. 9 shows the generation of photolithographic calibration patterns according to some embodiments;

FIG. 10 shows a flow chart of a method for calibrating an imaging system according to some embodiments;

FIG. 11 shows examples of imaging systems with hydrogel beads according to some embodiments;

FIGS. 12-1 to 12-3 show a chart with the refractive index of a range of different substances;

FIG. 13 shows a schematic view of flow cells according to some embodiments; and

FIG. 14 shows a schematic illustration of a system to perform the method according to FIG. 10 according to some embodiments.

### DETAILED DESCRIPTION

Embodiments of the present invention provide a calibration object for calibrating an imaging system and a method to calibrate the imaging system by means of the calibration object, which enable particular simple and efficient calibration with high ease of use for a user.

A calibration object is provided for calibrating an imaging system. The calibration object comprises a discrete entity with a calibration pattern, wherein the discrete entity is made of at least one transparent polymeric compound. The calibration pattern is an optically detectable pattern, which may be read-out by means of a microscope, for example. The discrete entity is transparent, in particular in order to enable detecting the calibration pattern. The calibration object enables calibration of imaging systems, in particular microscopes, in order to correct optical aberrations such as flat-field correction, distortion correction, spherical aberration correction, chromatic aberration correction, PSF measurement, and/or the correction of coma. The calibration object is suited for flow through imaging, for example, in an imaging cytometer or a flow-through based microscope. In addition, the calibration object enables easy handling of the calibration object and execution of the calibration by a user.

Preferably, the polymeric compound is a hydrogel. This enables easy formation and handling of the discrete entity. These discrete entities made of hydrogels are also named hydrogel beads.

Preferably, the discrete entity has a spherical or spheroidal shape. This shape of the discrete entity results in similar hydrodynamic properties of each discrete entity, irrespective of the particular calibration pattern in the discrete entity. This enables efficient handling of the discrete entity, in particular in flow-through based imaging systems.

In a preferred embodiment, the calibration pattern is distributed in the discrete entity inhomogeneously. This means, that the calibration pattern is not uniformly distributed in the discrete entity, for example the discrete entity is not dyed uniformly to generate the calibration pattern. Instead the calibration pattern forms discrete areas in the discrete entity. This enables a variety of calibration patterns in the same discrete entity and efficient calibration by means of the calibration object.

It is preferred, that the discrete entity has a diameter in the range of 50 μm to 250 μm. This enables similar hydrodynamic properties of each discrete entity and efficient handling of the discrete entity, in particular in flow-through based imaging systems.

It is preferred, that the discrete entity is in a liquid medium and a refractive index of the polymeric compound is in a range of +/−5% of a refractive index of the liquid medium, preferably the refractive index of the polymeric compound is in a range of +/−2.5% of the refractive index of the liquid medium. The similar refractive indexes of the polymeric compound and the liquid medium results in reduced or in a minimum of optical aberrations between the discrete entity and the liquid medium. This enables accurate imaging of the calibration object, in particular the calibration pattern, and therefore accurate calibration of the imaging system.

Preferably, the calibration pattern is radially symmetric. This enables easy imaging of the calibration object from various angles.

Preferably, the calibration pattern is spherical, in particular, the calibration pattern comprises a plurality of concentric spheres. This enables easy imaging of the calibration object from various angles.

In a preferred embodiment, the discrete entity comprises a first section, such as a core, and at least a second section, such as a layer preferably of uniform thickness, around the first section. The sections may be made of different polymeric compounds. Further, the sections of the discrete entity can each have different properties. These properties include physicochemical properties such as Young's modulus, refractive index, and chemical composition and functionalisation. This enables adapting the discrete entity to different use cases, for example, by adapting the refractive index of the individual sections of the discrete entity.

Preferably, the calibration pattern is arranged at least at an interface of the first section and the second section. This enables calibration objects with a large variety of calibration patterns to be generated.

Preferably, the calibration pattern comprises a dye. This may be a fluorescent dye or a dye that may be activated, deactivated or bleached photochemically, for example. This enables generating a large variety of calibration patterns.

It is preferred, that the calibration pattern comprises at least one of a fluorescent microbead, a microbead, a microsphere, a nanoruler or DNA origami-based nanostructure. In particular, this enables generating point-shaped calibration patters, which might be used to generate images to measure a point spread function of the imaging system.

According to another aspect, a method for calibrating an imaging system by means of at least one calibration object is provided. The method comprises imaging the calibration object with the imaging system to generate imaging data, wherein the calibration pattern of the calibration object has parameters with predetermined values; determining measured values of the parameters of the calibration pattern from the imaging data of the calibration object; comparing the measured values to the predetermined values; and generating image calibration information for the imaging system based on the comparison of the values. When imaging the calibration object, a single or several images may be acquired, in particular a (3D) stack of images or an image data stream may be acquired. The parameters of the calibration object may be its colour, in particular the wavelength of emitted fluorescent light, the brightness of the fluorescent light, the size, and the features of the shape of the calibration object. The predetermined values usually are known to the user. For example, the calibration pattern of the calibration object may be microbeads of a particular type, which is characterised by a particular size or a particular size distribution. This size may be used as the predetermined value. This enables easy and accurate calibration, in particular of flow-through based imaging systems.

Preferably, the image calibration information is utilised to correct images acquired by the imaging system. In particular, the image calibration information may be used to correct imaging data of the imaging system. This enables efficiently improving the imaging quality of the imaging system.

Preferably, the imaging system comprises or is an optofluidic imaging system. For example, the imaging system may comprise a microfluidic flow cell on a microfluidic chip with the flow cell used for imaging. This enables a flow-through imaging system with the calibration object being used for calibrating the imaging system in flow-through mode.

Preferably, the imaging system comprises a flow cell. The flow cell is used for imaging of the calibration object and of samples, for example. This enables a flow-through imaging system with the calibration object being used for calibrating the imaging system in flow-through mode.

Preferably, the imaging system comprises a light sheet microscope. When combined with the flow cell, the imaging plane of the light sheet microscope is in the flow cell. This enables imaging the calibration object in three dimensions, in particular, as a stack of images of the calibration object.

In a preferred embodiment, the predetermined values are averages for the calibration pattern. For example, the predetermined value may be the average diameter of a particular type of microbeads. This enables efficient calibration with the calibration object.

In a further preferred embodiment, the discrete entity comprises a marker and the predetermined values are associated with the marker. In this case, specific predetermined values may be determined for the specific calibration pattern and associated with the discrete entity that comprises the specific calibration pattern. The marker of the discrete entity is an optically detectable pattern, for example a phase or intensity object, that can be read-out by means of a microscope, for example. In case several calibration objects are used for calibration, the individual calibration objects can be identified and distinguished by the marker. As an example for a discrete entity comprising a marker, reference is made to the application PCT/EP2021/058785, the content of which is fully incorporated herein by reference.

Preferably, the predetermined values are initially determined by imaging the calibration object with a calibration imaging system. The imaging by the calibration imaging system enables determining the predetermined values with high accuracy and therefore enables good calibration and correction of the imaging system.

Preferably, the calibration imaging system is a confocal microscope. This enables determining the predetermined values with high accuracy.

Preferably, the image calibration information is utilised to correct images acquired by at least a second imaging system. In particular, the second imaging system is of the same type as the imaging system. This enables determining image calibration information on one particular imaging system and sharing the image calibration information with the second imaging system for efficient calibration.

In a preferred embodiment, the image calibration information is utilised to configure an adaptive optical element of the imaging system in order to correct images acquired by the imaging system. The adaptive optical element may be a deformable mirror, a spatial light modulator, a tuneable lens or a motorised correction collar of a microscope objective. This enables adapting the hardware of the imaging system based on the image calibration information, in particular such that the imaging system is capable to acquire images in which at least one optical aberration is at least partially corrected.

In a preferred embodiment, at least a second calibration object is imaged with the imaging system or a second imaging system, and the image calibration information is generated based on the imaging data generated for all imaged calibration objects. This enables efficient and high-quality calibration of the imaging system.

In a preferred embodiment, the image calibration information may be generated on the first or second imaging device, or in a remote networked data centre such as a cloud.

In a preferred embodiment, the steps of comparing the measured values to the predetermined values and/or generating the image calibration information are performed using machine learning, deep learning or artificial intelligence methods. Examples of these methods include support vector machines, artificial neural networks incl. dense neural networks, deep neural networks, deep belief networks, graph neural networks, recurrent neural networks, fully connected neural networks, convolutional neural networks, convolutional encoders-decoders, generative adversarial networks, and U-Net. This enables accurate generating of the image calibration information.

In a further aspect a method for manufacturing a calibration object is provided, configured to calibrate an imaging system. The method comprises the following steps: forming a discrete entity of at least one transparent polymeric compound; and providing a calibration pattern in the discrete entity to form the calibration object. The polymeric compound may be a hydrogel. This enables flexible manufacture of calibration objects.

In particular, the discrete entity is formed by lithography, microfluidics, emulsification or electrospraying.

Preferably, the calibration pattern is generated by means of lithography, in particular of photolithography or 2-photon lithography.

In the sense of this document “pattern” refers to an optically detectable pattern, which may be a pre-determined pattern or a random or pseudorandom distribution of, for example, phase or intensity objects.

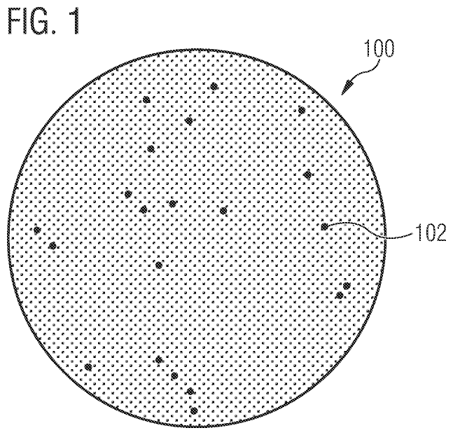

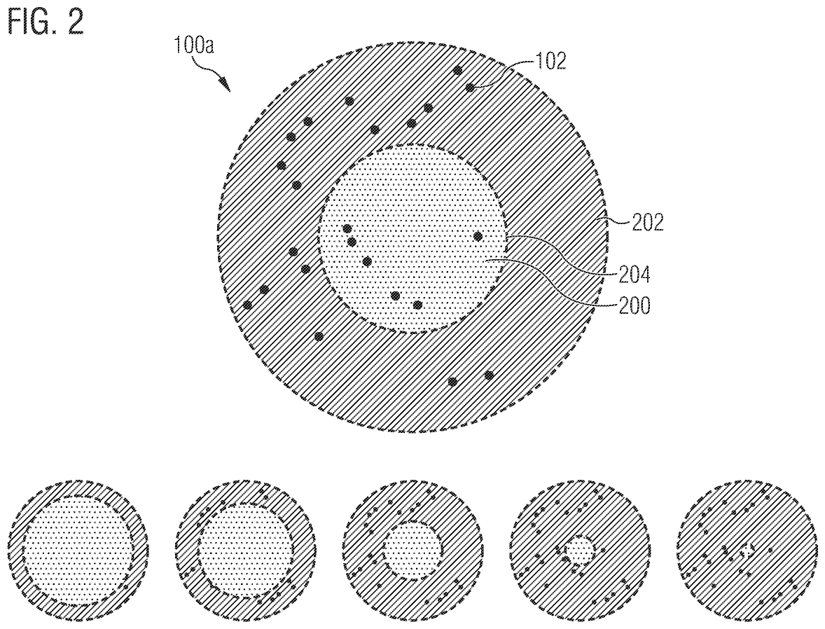

FIG. 1 is a schematic view of a hydrogel bead 100, as an example of a discrete entity. The hydrogel bead 100 contains a calibration pattern in the form of a plurality of microbeads 102 distributed in the hydrogel bead 100. The discrete entity with the calibration pattern is the calibration object. The shown hydrogel bead 100 is one example of a plurality of hydrogel beads. The hydrogel bead 100 is made of a polymeric compound, in particular, a polymeric compound that forms a hydrogel and that is substantially transparent. Transparent meaning, that light, in particular visible light, can pass through the hydrogel bead 100, such that the microbeads 102 can be clearly imaged within the hydrogel bead 100. The polymeric compound may be of natural or synthetic origin, including for example, agarose, alginate, chitosan, hyaluronan, dextran, collagen and fibrin as well as poly(ethylene glycol), poly(hydroxyethyl methacrylate), poly(vinyl alcohol) and poly(caprolactone). Further examples include basement membrane extracts, which may include Laminin I, Collagen I, Collagen IV, Vitronectin and Fibronectin amongst others, and extracellular matrix preparations, including for example, Cultrex, Matrigel, or Jellagel. The hydrogel bead 100 may be made of a single or several different polymeric compounds. Further the hydrogel bead 100 may be made out of a synthetic polymer such as poly(acrylamide) or BIO-133 (MyPolymers, Ness-Ziona, Israel).

FIG. 2 shows a further hydrogel bead 100a. The hydrogel bead 100a comprises several sections such as an inner core 200, an outer layer 202 around the core 200. Each of the sections can be made of a particular polymeric compound. The inner core 200 may be spherical, for example. The area between the inner core 200 and the outer layer 202 forms an interface 204 between the sections. The proportion of the volumes of the inner core 200 and the outer layer 202 may be varied, to give hydrogel beads 100a. Further, the hydrogel bead 100a may have additional layers 202. The hydrogel bead 100a may comprise a layer of dye arranged at the interface 204. This layer of dye may be a part of a calibration pattern in addition to the microbeads 102. Alternatively, the hydrogel bead 100a may comprise no microbeads 102, with the dye layer being the calibration pattern. In addition or alternatively, a dye layer may be arranged on the outer surface of the hydrogel bead 100, 100a.

In addition, hydrogel beads 100, 100a may comprise an outer shell, the outer shell encapsulating the respective hydrogel bead. Moreover, the hydrogel beads 100, 100a may comprise sections that are made of other compounds that do not form hydrogels. Thus, the sections of the hydrogel bead 100, 100a can each have different properties. These properties include physicochemical properties such as Young's modulus, refractive index, and chemical composition and functionalisation.

The shape of the hydrogel bead 100, 100a is spherical. Alternatively, the hydrogel bead 100 may have a different shape such as a spheroid. The diameter of the hydrogel bead 100 may be in the range of 10 μm to 10 mm. Preferred ranges are 10 μm to 100 μm, 50 μm to 250 μm and 500 μm to 5 mm.

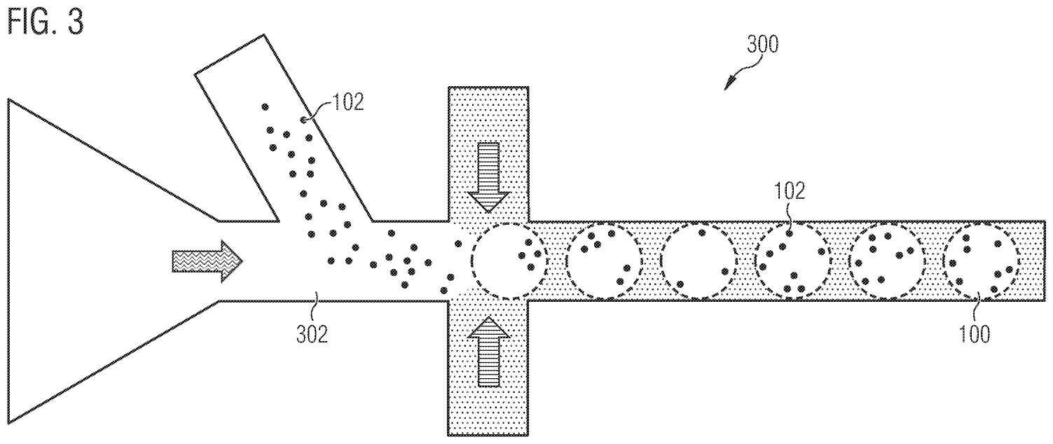

FIG. 3 shows a schematic view of a microfluidic device 300 for forming hydrogel beads 100. The hydrogel bead 100 can be formed, for example, by electrospray, emulsification, lithography, 3D printing and microfluidic approaches. The shown microfluidic device 300 comprises several channels through which non-polymerised hydrogel 302 and other liquids can flow. Further, microbeads 102 may be added, before forming the hydrogel bead 100 and polymerising the hydrogel. During formation of the hydrogel bead 100 further compounds and structures can be included in the hydrogel bead 100.

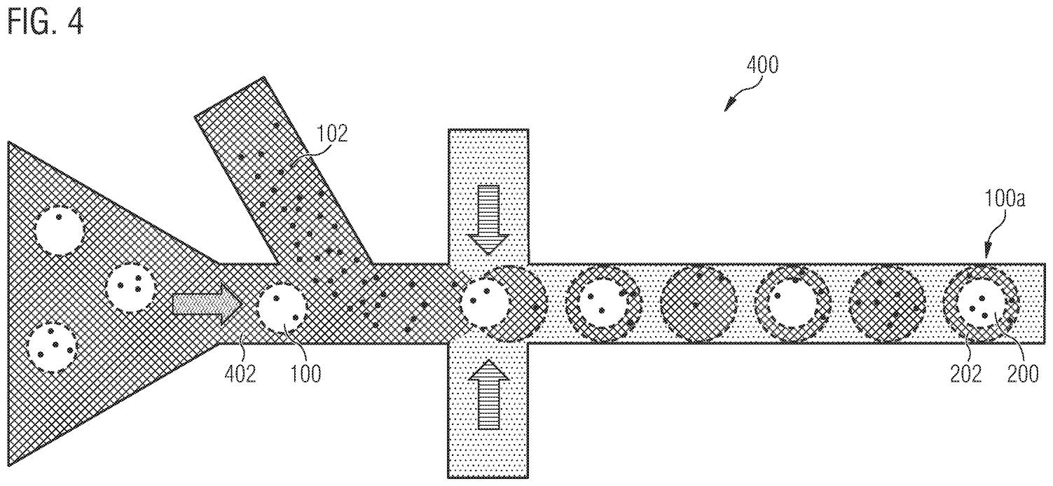

FIG. 4 shows a schematic view of a microfluidic device 400 for forming hydrogel beads 100a. The hydrogel bead 100a can be formed, for example, by microfluidic approaches. The shown microfluidic device 400 comprises several channels through which non-polymerised hydrogel 402 and other liquids can flow. In addition, the already formed hydrogel beads 100 can be used to form the core 200, whereas the hydrogel 402 forms the layer 202 of the hydrogel bead 100a. Further, microbeads 102 may be added, before forming the hydrogel bead 100a and polymerising the hydrogel.

The hydrogel beads 100, 100a comprise the plurality of microbeads 102. The microbeads 102 are included and randomly dispersed in the hydrogel bead 100, 100a during the formation of the hydrogel bead 100. After the formation of the hydrogel bead 100, 100a, the microbeads 102 are set in place in the hydrogel bead 100, 100a. This means the microbeads 102 do not change their location in the hydrogel bead 100, 100a once the hydrogel bead 100, 100a is formed, resulting in substantially stable discrete entities or hydrogel beads 100, 100a. The diameter of the microbeads 102 is in the range of 50 nm to 500 nm.

As mentioned already, the microbeads 102 and the dye layers, for example at the interface 204, may be part of a calibration pattern.

The microbeads 102 may in particular be fluorescent microbeads 102. The fluorescent microbeads 102 comprise, in particular are coated with, fluorescent dyes. Similarly, the dye layers may comprise fluorescent dyes. These dyes may vary in parameters such as fluorescence wavelength, fluorescence intensity, excitation wavelength and fluorescence lifetime. In addition, the microbeads 102 and the dye layers may vary in parameters such as their size and shape. These microbeads 120 and dye layers may be part of a calibration pattern or may be the calibration pattern. The calibration pattern may be used to determine image calibration information for an imaging system.

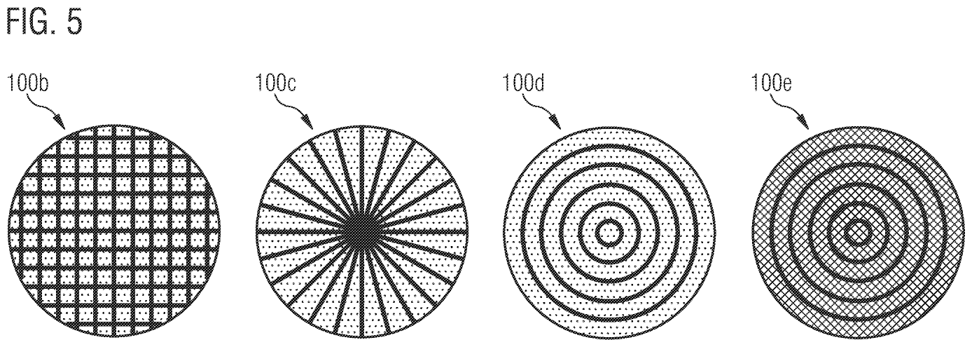

FIG. 5 shows further embodiments of calibration patterns of hydrogel beads 100b, 100c, 100d, 100e. Hydrogel bead 100b comprises a grid shaped calibration pattern. Hydrogel bead 100c comprises a star shaped calibration pattern, in particular a Siemens star. Hydrogel bead 100d comprises a calibration pattern of concentric spheres. Hydrogel bead 100e comprises a calibration pattern of concentric spheres with the bead 100e made of a different hydrogel than hydrogel bead 100d. The hydrogel beads 100d, 100e may, for example be made from different sections, with the calibration pattern arranged at the interface 204 between each section, such that the calibration pattern is generated during formation of the hydrogel bead.

Alternatively, the calibration patterns of the hydrogel beads 100b to 100e may be generated photolithographically after the formation of the respective hydrogel bead. This can be achieved by including compounds in the hydrogel beads 100b to 100e when forming the hydrogel bead 100b to 100e that generate the calibration pattern after the formation of the hydrogel bead 100b to 100e. Compounds can be included in the hydrogel bead 100b to 100e that can be activated, deactivated or bleached photochemically after formation of the hydrogel bead 100b to 100e. In a subsequent lithographic, in particular in a photolithographic step, the compounds may be activated, deactivated or bleached photochemically by means of a focused light beam, or by imaging or projecting a pattern on the hydrogel bead 100b to 100e.

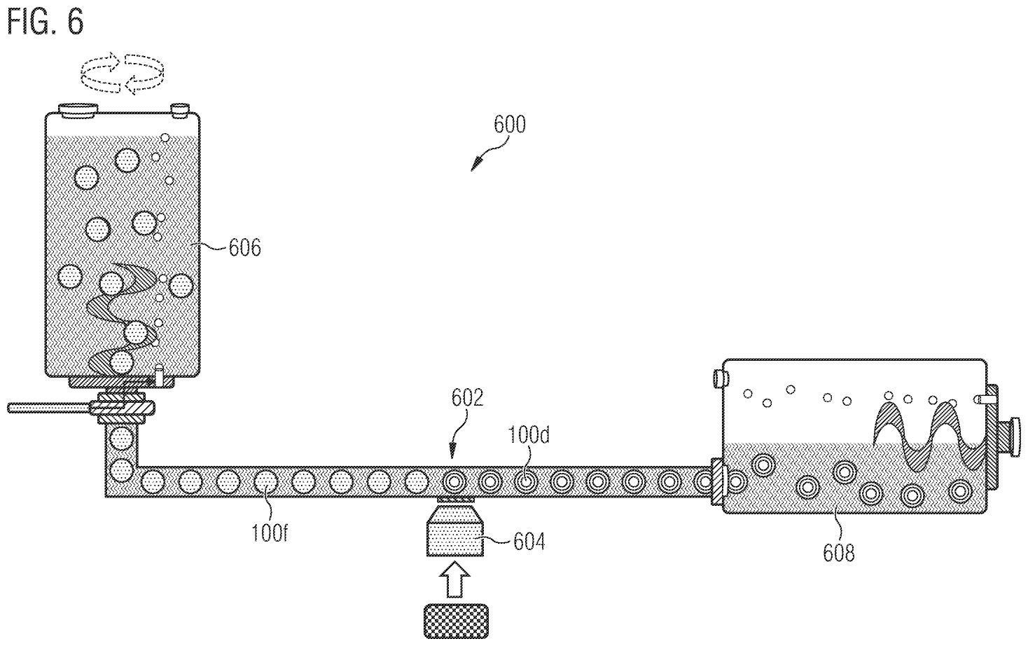

FIG. 6 shows a schematic view of a lithographic device 600 for generating calibration patterns continuously. This lithographic device, in particular a photolithographic device 600, may be used to generate photochemically or photophysically changed areas in the hydrogel bead 100b to 100e as the calibration pattern. The photolithographic step can be performed sequentially in a flow cell 602. A focused light beam is projected onto blank hydrogel beads 100f by means of an objective 604 in order to generate the calibration pattern. In the example according to FIG. 6, the hydrogel bead 100d is generated. The hydrogel beads 100d, 100f flow through the flow cell 602 from a first tank 606 to a second tank 608.

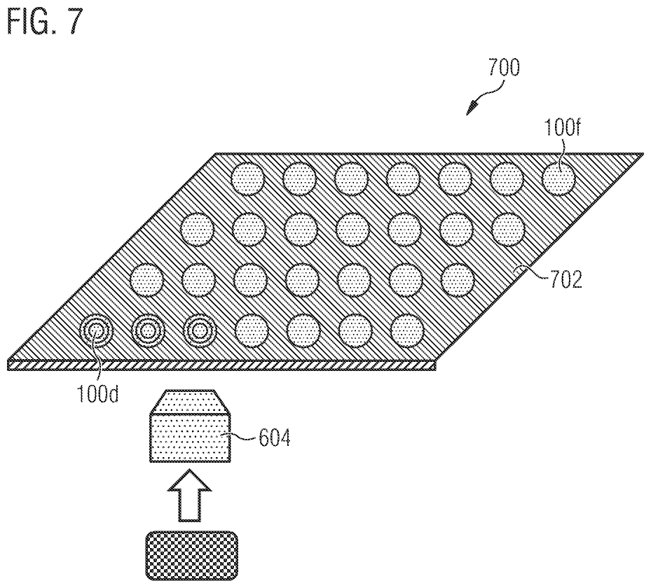

FIG. 7 shows a schematic view of a lithographic device 700 for generating calibration patterns in batch. The lithographic device, in particular a photolithographic device 700, may be used to generate photochemically or photophysically changed areas in the hydrogel bead 100b to 100e as the calibration pattern. The blank hydrogel beads 100f are stored in a tray 702. The tray 702 may be a glass slide with indentations for individual beads, a microplate, or a similar carrier, for example. The focused light beam is then projected onto the hydrogel beads 100f by means of the objective 604 in order to generate the calibration pattern.

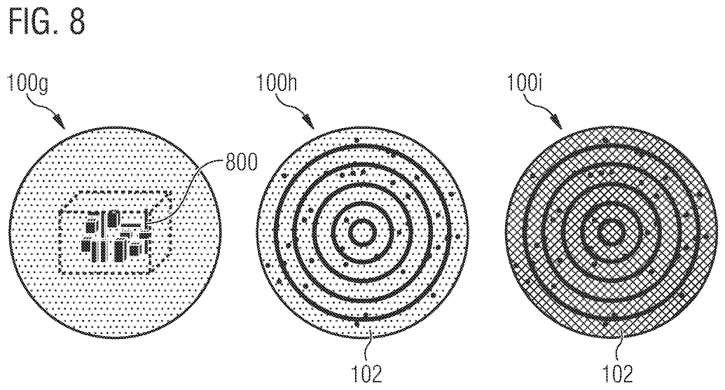

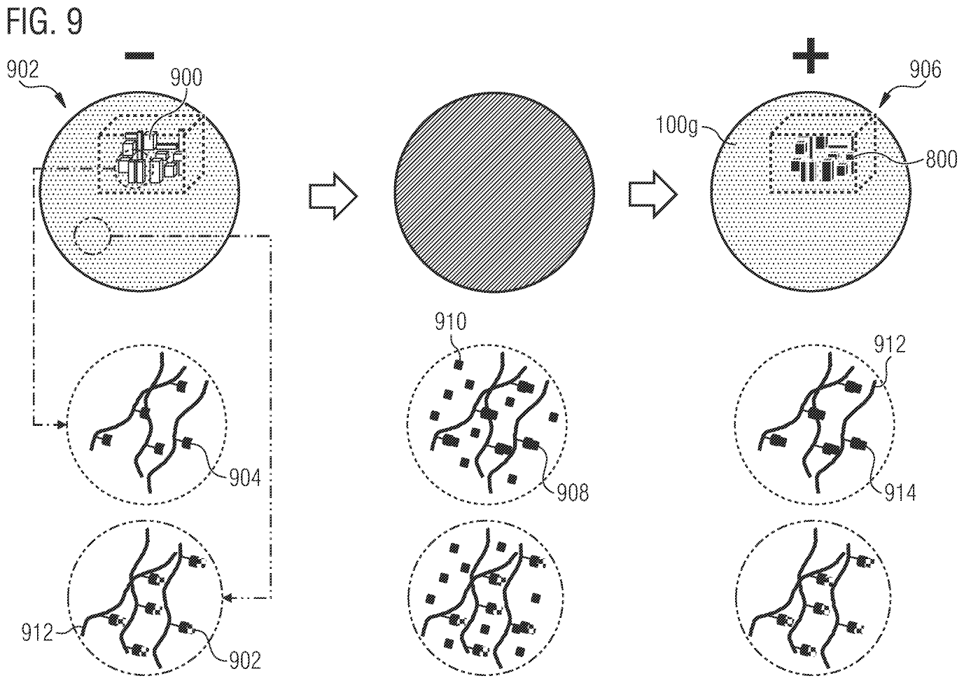

FIG. 8 further embodiments of calibration patterns. Hydrogel bead 100g comprises a calibration pattern with a 3D-barcode 800. The 3D-barcode 800 may be generated photolithographically, for example. Hydrogel beads 100h, 100i comprise the calibration pattern of concentric spheres, similar to the hydrogel beads 100d, 100e. In addition, the calibration patterns of the hydrogel beads 100h, 100i comprise microbeads 102.

FIG. 9 shows the generation of photolithographic calibration patterns. Photolithographically generated patterns of photochemically or photophysically changed areas 900 might be either positives or negatives. Negatives 902, for example, may be generated by uncaging or deprotecting protected binding sites 902 photochemically, which generates deprotected binding sites 904 in the respective areas 900. Negatives 902 may then be developed into positives 906 by coupling dyes 908 covalently using click chemistries to unprotected reactive sites 904 for example, which can be efficiently performed by bathing hydrogel beads in activated dye solution 910 followed by washing out unbound dye molecules 910. As the protected binding sites 904 can be covalently linked to the hydrogel polymer 912, covalently coupled dye molecules 914 establish the substantially stationary calibration pattern 800 in the hydrogel bead 100g.

By generating a unique pattern of these specific locations, the calibration pattern is generated either directly (direct generation of the positive) or indirectly (direct generation of the negative followed by development which leads to the positive).

In any case, the calibration pattern is optically detectable, for example, as a phase or intensity object by means of a microscope. The hydrogel bead 100 needs to be transparent, at least to an extent that allows the sample 102 and the calibration pattern to be optically detectable.

In addition, the hydrogel beads 100, 100a to 100i may comprise a marker to uniquely recognise or identify a specific one of the hydrogel beads 100, 100a to 100i. The marker of one of the hydrogel beads 100, 100a to 100i is an optically detectable pattern, for example a phase or intensity object, that can be read-out by means of a microscope, for example. Specifically, the marker may be formed by a plurality of microbeads. When the hydrogel bead 100, 100a to 100i comprises a marker, information may be associated with that particular hydrogel bead 100, 100a to 100i. As an example for a discrete entity comprising a marker, reference is made to the application PCT/EP2021/058785.

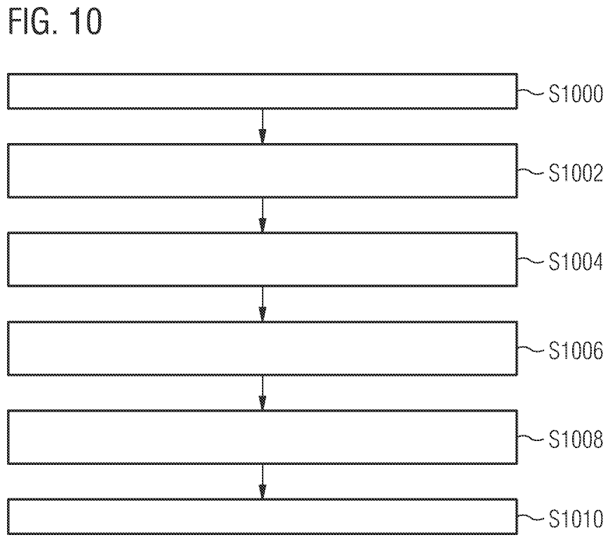

FIG. 10 shows a flow chart of a method for calibrating an imaging system. The method starts in step S1000. In step S1002 a calibration object, comprising the hydrogel bead 100 and the calibration pattern. The calibration pattern may be generated as described in this document. For example, the calibration pattern may be a plurality of fluorescent microbeads 102 with a set of parameters. The parameters may include the size of the microbeads, the colour of the fluorescent light and the brightness of the fluorescent light. Since the calibration pattern is actively added during or after formation of the hydrogel bead, the values of these parameters are predetermined and known to the user. For example, in case of the fluorescent microbeads 102, the calibration objects may be generated with microbeads 102 of a particular known size distribution and fluorescent intensity. The imaging is carried out by the imaging system to be calibrated. The generated image may be a single image, a plurality of images, or a three-dimensional stack of images of the calibration object.

In step S1004 the imaging data generated in step S1002 is analysed to measure the parameters of the calibration pattern to give measured values of the parameters. For example, the image data may be analysed by image segmentation to identify the calibration pattern in the image data. The segmented image data may then be used to measure values of the parameters of the identified calibration pattern.

In step S1006 the measured values are compared to the predetermined values. In case the imaging system provides a very good image quality little to no deviation of the measured values to the predetermined values is expected. In case imaging error occur, larger deviations may occur that can be determined by the comparison. For example, vignetting may be determined in case there is a reduction of the fluorescent intensity for those microbeads 102 in the periphery compared to the centre of the image.

In step S1008 image calibration information is generated based on the comparison in step S1006. The image calibration information may comprise instructions to correct images captured by the imaging system or instructions to configure an adaptive optical element such as a deformable mirror, a spatial light modulator, tuneable lenses or motorised correction collars of a microscope objective. Based on the image calibration information, images subsequently captured by the imaging system may be corrected. The method ends in step S1010.

Alternatively, the image calibration information generated in step S1008 may be based on several imaged calibration objects. This means that steps S1002 and S1004 may be repeated iteratively for several different calibration objects. This generates a set of predetermined values and measured values, which are compared in step S1006.

Furthermore, the measured values may be generated with more than one of the imaging systems. For example, a first calibration object is imaged by a first imaging system to generate first measured values of the parameters of the calibration pattern of the first calibration object. A second calibration object may be imaged by a second imaging system to generate second measured values of the parameters of the calibration pattern of the second calibration object. The first and second imaging systems are of the same type and build. The first and second measured values may then be used to generate the image calibration information. This may be in a remote computer facility, for example, a cloud, which the first and second imaging systems are connected to. Alternatively, one of the first or second imaging system may transfer the measured values to the other one of the imaging systems to perform only step S1008 on the other one of the imaging systems. This means that at least optical aberrations inherent to the type of the imaging system may be determined and corrected.

In addition or alternatively, the steps S1006 and S1008 may use machine learning, deep learning or artificial intelligence methods in order to generate the image calibration information from the predetermined and measured values. In particular, the predetermined values and the measured values may be used as training data. The measured values may be determined on the first imaging system and/or the second imaging system. In addition or alternatively, the predetermined values may be determined by means of a calibration imaging system, as described below. The predetermined values are compared to the measured values by machine learning, deep learning or artificial intelligence methods to generate the image calibration information. Examples of appropriate methods include support vector machines, artificial neural networks incl. but not limited to dense neural networks, recurrent neural networks, fully connected neural networks, convolutional neural networks, convolutional encoders-decoders, generative adversarial networks, U-Net.

In addition, the calibration object imaged in step S1002 may comprise one of the markers to uniquely identify the calibration object. This enables associating information of the calibration object with the specific calibration object. For example, the predetermined values of the calibration patterns may be associated with the particular calibration object.

Further in addition, at least some of the predetermined values of the calibration pattern may be determined by means of the calibration imaging system prior to being imaged by the imaging system in step S1002. In case the predetermined values are determined by the calibration imaging system, the predetermined values may be associated with the marker of the specific calibration object, which was imaged by the calibration imaging system. The calibration imaging system is for example a confocal microscope and generates high-quality images. This enables determining the predetermined values with high accuracy. For example, the calibration pattern may comprise fluorescent microbeads 102 and the calibration imaging system may be used to determine the predetermined values of the fluorescent emission intensity parameter for each microbead. If several calibration objects are imaged in step S1002, the predetermined data of each may be associated with the respective calibration object. When the marker and the calibration pattern both comprise microbeads, the marker and calibration pattern may comprise microbeads that differ in a parameter such as their emission wavelength to enable easy discrimination between the marker and the calibration pattern.

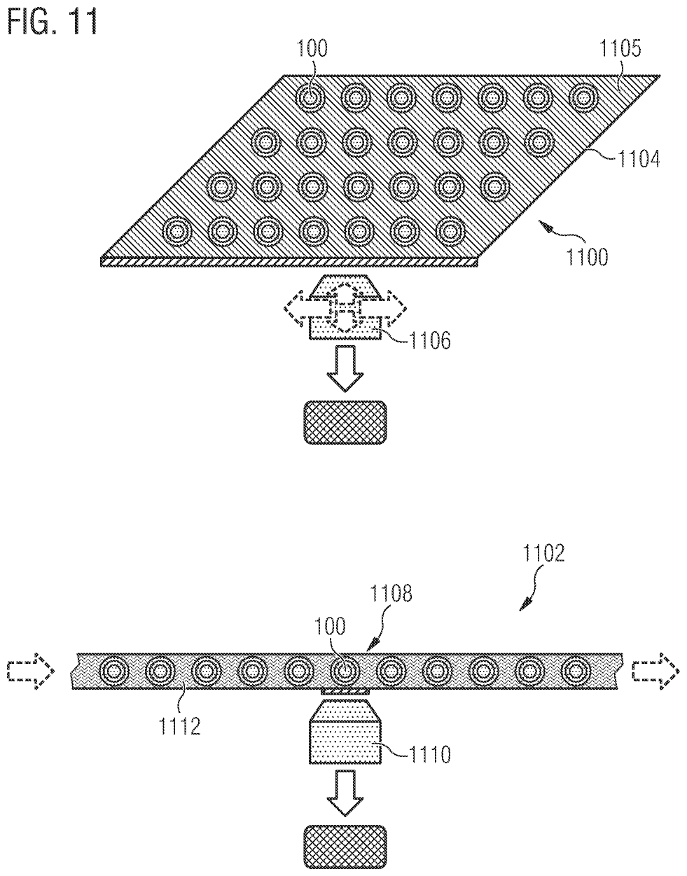

FIG. 11 shows examples of imaging systems 1100, 1102 with hydrogel beads with calibration patterns. The imaging system 1100 is configured to image hydrogel beads 100 in a tray 1104. The tray 1104 may be a glass slide with indentations for individual hydrogel beads 100, a microplate, or a similar carrier, for example. The individual hydrogel beads 100 may be suspended in a liquid 1105 in the tray 1104. The imaging system 1100 comprises a moveable objective 1106 in order to image a plurality of the hydrogel beads 100.

The imaging system 1102 is an optofluidic system, comprising a flow cell 1108 and an objective 1110 for imaging the hydrogel beads 100 continuously. The hydrogel beads 100 are pumped through the flow cell 1108 in a liquid 1112. Such an imaging system 1102 may also be an imaging flow cytometer or a flow-through based microscope.

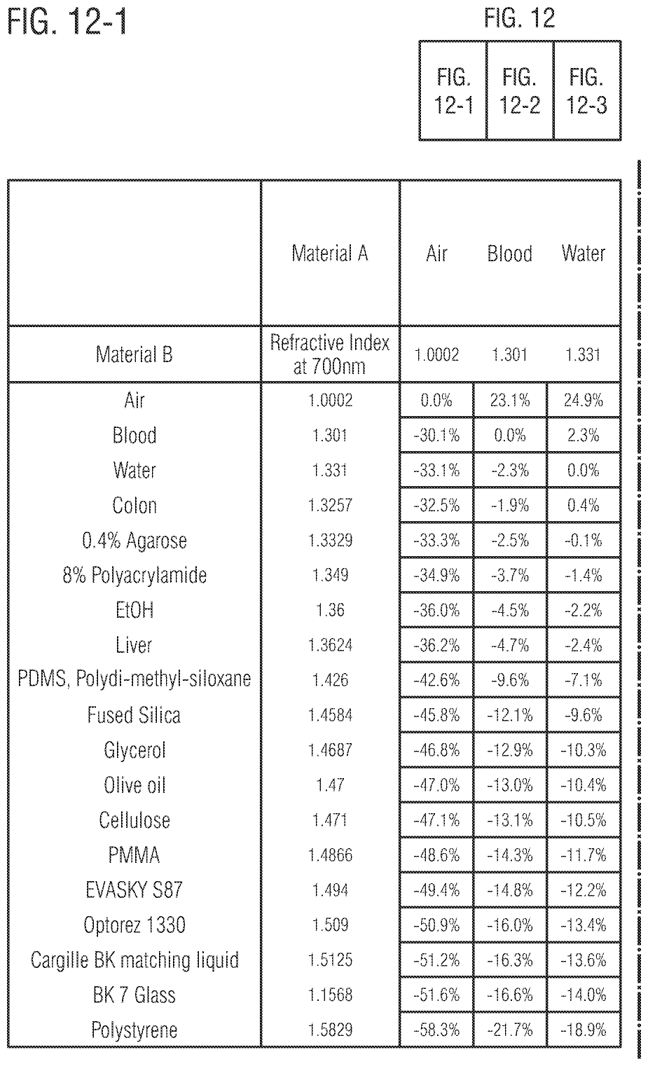

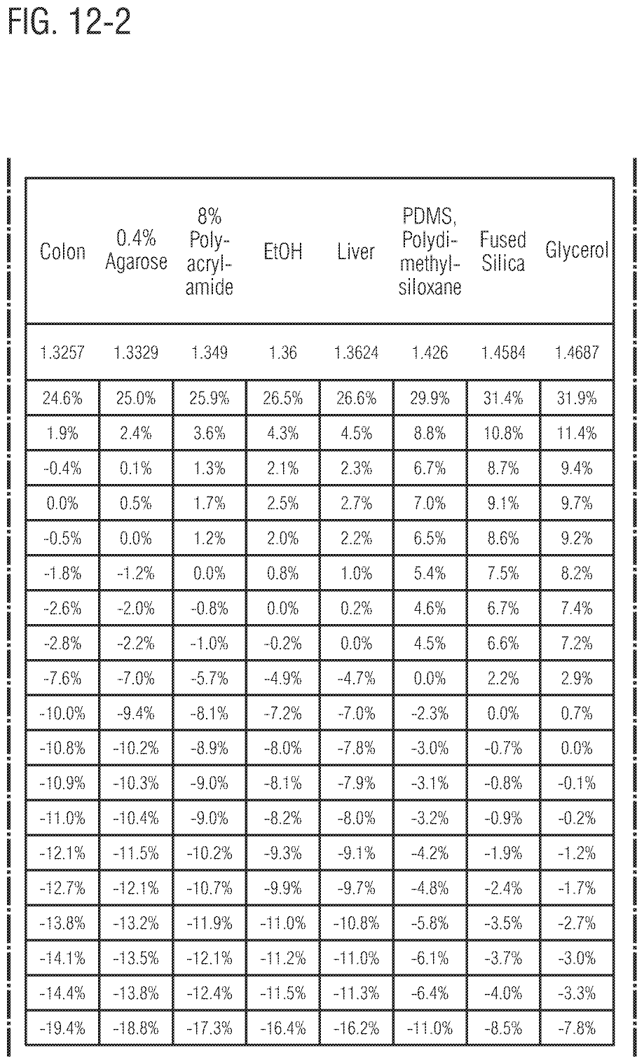

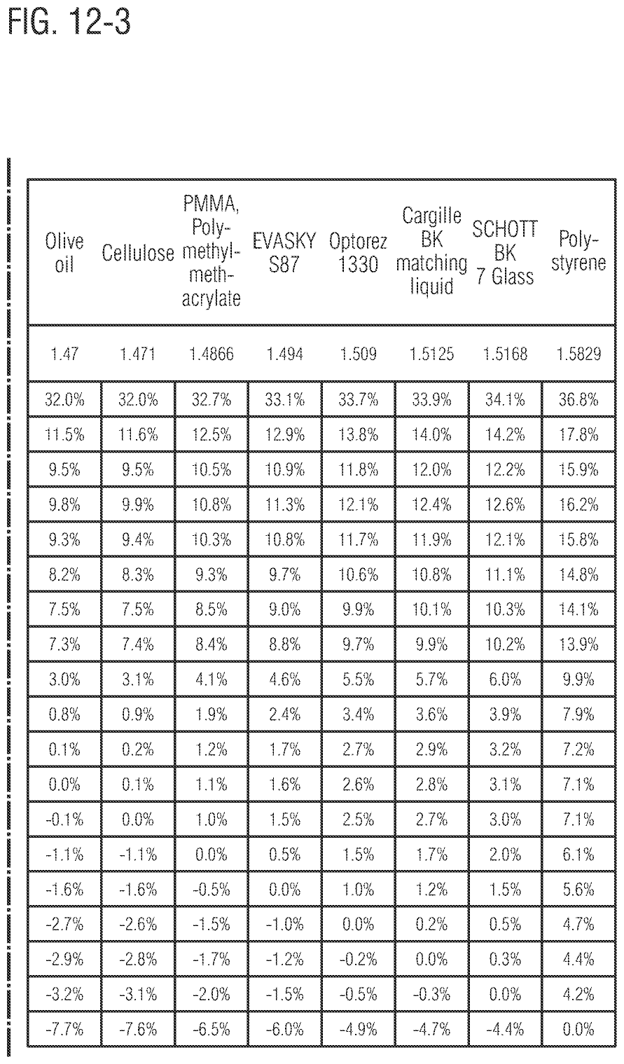

FIG. 12 shows a chart with the refractive index of a range of different substances and the percentage differences between the substances' respective refractive indexes. For example, the liquid 1105, 1112 the hydrogel bead 100 is suspended in is water or a water-based buffer with a refractive index at 700 nm of 1.33 and the polymer the hydrogel bead 100 is formed of has a refractive index of 1.33, for example, 0.4% agarose or other hydrogels and compositions (e.g. collagens) or polymers such as 8% poly acrylamide.

This is preferable, as water is biocompatible and the primary solvent used for buffers, media, additives, and hydrogels, which are used in life science and diagnostic cell culture and imaging applications. For this reason, there are also numerous detection objectives which are corrected for water and optimized to work with samples in aqueous environments such as cell suspensions or scaffold-based 3D cell culture samples (e.g. hydrogel embedded spheroids, tumoroids, organoids). Such water immersion objectives are available for use with and without a cover-glass and are also available with motorized correction collars that allow for fine adjustments and help to minimize spherical aberrations. This is also preferable as numerous staining reactions and labeling protocols are based on aqueous buffers.

In any case, by matching the refractive index of the liquid 1105, 1112 to the refractive index of the polymer the hydrogel bead 100 is formed of, aberrations may be reduced. In particular, the refractive indexes should not deviate from one another by more than +/−5%, preferably, by not more than +/−2.5%.

In a preferred embodiment of the invention the calibration objects are therefore made of polymers with a refractive index substantially matched to the one of water, i.e. 1.331+/−2.5%, like for example LUMOX™, BIO-133 or similar polymers.

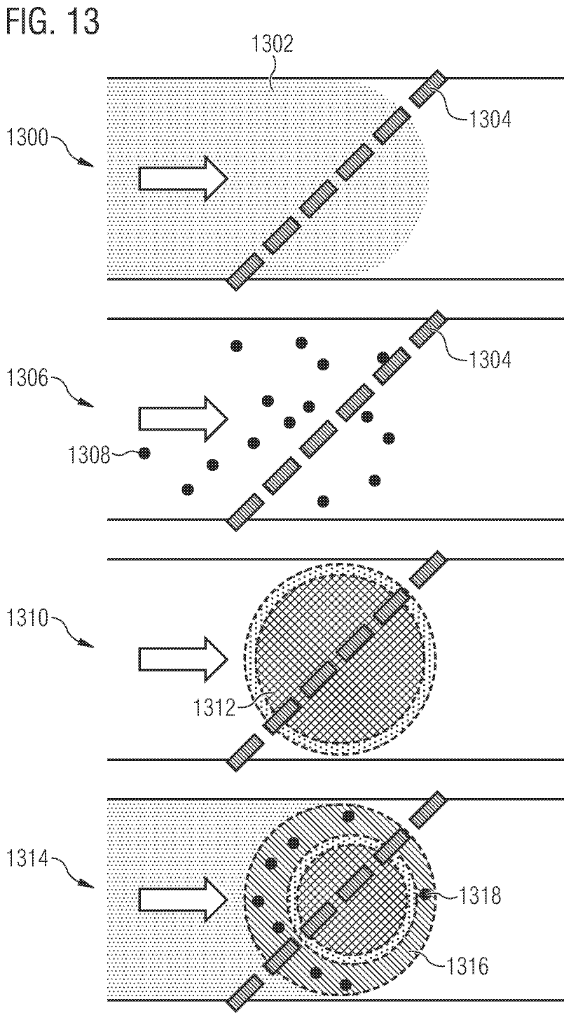

FIG. 13 shows a schematic view of flow cells. Flow cell 1300 shows a calibration without a calibration object. Flow cell 1300 is shown with a dye solution 1302 flowing through it, for example, a fluorescein solution. The use of a dye solution allows determining undesirable effects such as vignetting and apply a flat-field correction. A focus plane 1304 of a light sheet microscope is indicated.

Flow cell 1306 shows a calibration without a calibration object, instead individual microbeads 1308 in suspension flow through the flow cell 1306. This may be used to correct spherical aberration, chromatic aberration and coma.

In flow cell 1310 there is a calibration object 1312 with a calibration pattern at the interface 204 between sections. This enables distortion correction, spherical aberration correction, chromatic aberration correction and coma correction.

In the flow cell 1314 there is a calibration object 1316 with a calibration pattern at the interface 204 between sections and with microbeads 1318. This enables flat-field correction, distortion correction, spherical aberration correction, chromatic aberration correction and coma correction.

In addition, calibration patterns with more complex shapes as shown in hydrogel beads 100b, 100c, 100d, 100e are possible. In particular the star pattern 100c enables determining the optical transfer function of an optical imaging system, for example.

As used herein the term “and/or” includes any and all combinations of one or more of the associated listed items and may be abbreviated as “/”.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

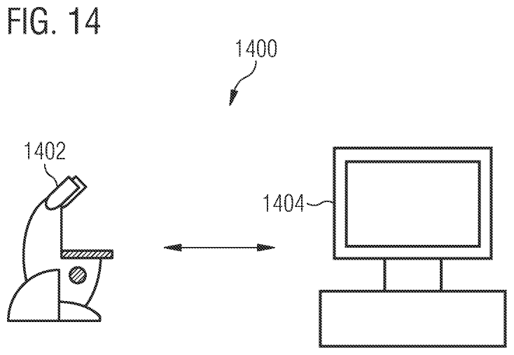

Some embodiments relate to a microscope comprising a system as described in connection with one or more of the FIGS. 1 to 13. Alternatively, a microscope may be part of or connected to a system as described in connection with one or more of the FIGS. 1 to 13. FIG. 14 shows a schematic illustration of a system 1400 configured to perform a method described herein. The system 1400 comprises a microscope 1402 and a computer system 1404. The microscope 1402 is configured to take images and is connected to the computer system 1404. The computer system 1404 is configured to execute at least a part of a method described herein. The computer system 1404 may be configured to execute a machine learning algorithm. The computer system 1404 and microscope 1402 may be separate entities but can also be integrated together in one common housing. The computer system 1404 may be part of a central processing system of the microscope 1402 and/or the computer system 1404 may be part of a subcomponent of the microscope 1402, such as a sensor, an actor, a camera or an illumination unit, etc. of the microscope 1402.

The computer system 1404 may be a local computer device (e.g. personal computer, laptop, tablet computer or mobile phone) with one or more processors and one or more storage devices or may be a distributed computer system (e.g. a cloud computing system with one or more processors and one or more storage devices distributed at various locations, for example, at a local client and/or one or more remote server farms and/or data centers). The computer system 1404 may comprise any circuit or combination of circuits. In one embodiment, the computer system 1404 may include one or more processors which can be of any type. As used herein, processor may mean any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, a field programmable gate array (FPGA), for example, of a microscope or a microscope component (e.g. camera) or any other type of processor or processing circuit. Other types of circuits that may be included in the computer system 1404 may be a custom circuit, an application-specific integrated circuit (ASIC), or the like, such as, for example, one or more circuits (such as a communication circuit) for use in wireless devices like mobile telephones, tablet computers, laptop computers, two-way radios, and similar electronic systems. The computer system 1404 may include one or more storage devices, which may include one or more memory elements suitable to the particular application, such as a main memory in the form of random access memory (RAM), one or more hard drives, and/or one or more drives that handle removable media such as compact disks (CD), flash memory cards, digital video disk (DVD), and the like. The computer system 1404 may also include a display device, one or more speakers, and a keyboard and/or controller, which can include a mouse, trackball, touch screen, voice-recognition device, or any other device that permits a system user to input information into and receive information from the computer system 1404.

Some or all of the method steps may be executed by (or using) a hardware apparatus, like for example, a processor, a microprocessor, a programmable computer or an electronic circuit. In some embodiments, some one or more of the method steps may be executed by such an apparatus.

Depending on certain implementation requirements, embodiments of the invention can be implemented in hardware or in software. The implementation can be performed using a non-transitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may, for example, be stored on a machine-readable carrier.

Other embodiments comprise the computer program for performing one of the methods described herein, stored on a machine-readable carrier.

In other words, an embodiment of the present invention is, therefore, a computer program having a program code for performing one of the methods described herein, when the computer program runs on a computer.

A further embodiment of the present invention is, therefore, a storage medium (or a data carrier, or a computer-readable medium) comprising, stored thereon, the computer program for performing one of the methods described herein when it is performed by a processor. The data carrier, the digital storage medium or the recorded medium are typically tangible and/or non-transitionary. A further embodiment of the present invention is an apparatus as described herein comprising a processor and the storage medium.

A further embodiment of the invention is, therefore, a data stream or a sequence of signals representing the computer program for performing one of the methods described herein. The data stream or the sequence of signals may, for example, be configured to be transferred via a data communication connection, for example, via the internet.

A further embodiment comprises a processing means, for example, a computer or a programmable logic device, configured to, or adapted to, perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example, a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

Embodiments may be based on using a machine-learning model or machine-learning algorithm. Machine learning may refer to algorithms and statistical models that computer systems may use to perform a specific task without using explicit instructions, instead relying on models and inference. For example, in machine-learning, instead of a rule-based transformation of data, a transformation of data may be used, that is inferred from an analysis of historical and/or training data. For example, the content of images may be analyzed using a machine-learning model or using a machine-learning algorithm. In order for the machine-learning model to analyze the content of an image, the machine-learning model may be trained using training images as input and training content information as output. By training the machine-learning model with a large number of training images and/or training sequences (e.g. words or sentences) and associated training content information (e.g. labels or annotations), the machine-learning model “learns” to recognize the content of the images, so the content of images that are not included in the training data can be recognized using the machine-learning model. The same principle may be used for other kinds of sensor data as well: By training a machine-learning model using training sensor data and a desired output, the machine-learning model “learns” a transformation between the sensor data and the output, which can be used to provide an output based on non-training sensor data provided to the machine-learning model. The provided data (e.g. sensor data, meta data and/or image data) may be pre-processed to obtain a feature vector, which is used as input to the machine-learning model.

Machine-learning models may be trained using training input data. The examples specified above use a training method called “supervised learning”. In supervised learning, the machine-learning model is trained using a plurality of training samples, wherein each sample may comprise a plurality of input data values, and a plurality of desired output values, i.e. each training sample is associated with a desired output value. By specifying both training samples and desired output values, the machine-learning model “learns” which output value to provide based on an input sample that is similar to the samples provided during the training. Apart from supervised learning, semi-supervised learning may be used. In semi-supervised learning, some of the training samples lack a corresponding desired output value. Supervised learning may be based on a supervised learning algorithm (e.g. a classification algorithm, a regression algorithm or a similarity learning algorithm. Classification algorithms may be used when the outputs are restricted to a limited set of values (categorical variables), i.e. the input is classified to one of the limited set of values. Regression algorithms may be used when the outputs may have any numerical value (within a range). Similarity learning algorithms may be similar to both classification and regression algorithms but are based on learning from examples using a similarity function that measures how similar or related two objects are. Apart from supervised or semi-supervised learning, unsupervised learning may be used to train the machine-learning model. In unsupervised learning, (only) input data might be supplied and an unsupervised learning algorithm may be used to find structure in the input data (e.g. by grouping or clustering the input data, finding commonalities in the data). Clustering is the assignment of input data comprising a plurality of input values into subsets (clusters) so that input values within the same cluster are similar according to one or more (pre-defined) similarity criteria, while being dissimilar to input values that are included in other clusters.

Reinforcement learning is a third group of machine-learning algorithms. In other words, reinforcement learning may be used to train the machine-learning model. In reinforcement learning, one or more software actors (called “software agents”) are trained to take actions in an environment. Based on the taken actions, a reward is calculated. Reinforcement learning is based on training the one or more software agents to choose the actions such, that the cumulative reward is increased, leading to software agents that become better at the task they are given (as evidenced by increasing rewards).

Furthermore, some techniques may be applied to some of the machine-learning algorithms. For example, feature learning may be used. In other words, the machine-learning model may at least partially be trained using feature learning, and/or the machine-learning algorithm may comprise a feature learning component. Feature learning algorithms, which may be called representation learning algorithms, may preserve the information in their input but also transform it in a way that makes it useful, often as a pre-processing step before performing classification or predictions. Feature learning may be based on principal components analysis or cluster analysis, for example.

In some examples, anomaly detection (i.e. outlier detection) may be used, which is aimed at providing an identification of input values that raise suspicions by differing significantly from the majority of input or training data. In other words, the machine-learning model may at least partially be trained using anomaly detection, and/or the machine-learning algorithm may comprise an anomaly detection component.

In some examples, the machine-learning algorithm may use a decision tree as a predictive model. In other words, the machine-learning model may be based on a decision tree. In a decision tree, observations about an item (e.g. a set of input values) may be represented by the branches of the decision tree, and an output value corresponding to the item may be represented by the leaves of the decision tree. Decision trees may support both discrete values and continuous values as output values. If discrete values are used, the decision tree may be denoted a classification tree, if continuous values are used, the decision tree may be denoted a regression tree.

Association rules are a further technique that may be used in machine-learning algorithms. In other words, the machine-learning model may be based on one or more association rules. Association rules are created by identifying relationships between variables in large amounts of data. The machine-learning algorithm may identify and/or utilize one or more relational rules that represent the knowledge that is derived from the data. The rules may e.g. be used to store, manipulate or apply the knowledge.

Machine-learning algorithms are usually based on a machine-learning model. In other words, the term “machine-learning algorithm” may denote a set of instructions that may be used to create, train or use a machine-learning model. The term “machine-learning model” may denote a data structure and/or set of rules that represents the learned knowledge (e.g. based on the training performed by the machine-learning algorithm). In embodiments, the usage of a machine-learning algorithm may imply the usage of an underlying machine-learning model (or of a plurality of underlying machine-learning models). The usage of a machine-learning model may imply that the machine-learning model and/or the data structure/set of rules that is the machine-learning model is trained by a machine-learning algorithm.

For example, the machine-learning model may be an artificial neural network (ANN). ANNs are systems that are inspired by biological neural networks, such as can be found in a retina or a brain. ANNs comprise a plurality of interconnected nodes and a plurality of connections, so-called edges, between the nodes. There are usually three types of nodes, input nodes that receiving input values, hidden nodes that are (only) connected to other nodes, and output nodes that provide output values. Each node may represent an artificial neuron. Each edge may transmit information, from one node to another. The output of a node may be defined as a (non-linear) function of its inputs (e.g. of the sum of its inputs). The inputs of a node may be used in the function based on a “weight” of the edge or of the node that provides the input. The weight of nodes and/or of edges may be adjusted in the learning process. In other words, the training of an artificial neural network may comprise adjusting the weights of the nodes and/or edges of the artificial neural network, i.e. to achieve a desired output for a given input.

Alternatively, the machine-learning model may be a support vector machine, a random forest model or a gradient boosting model. Support vector machines (i.e. support vector networks) are supervised learning models with associated learning algorithms that may be used to analyze data (e.g. in classification or regression analysis). Support vector machines may be trained by providing an input with a plurality of training input values that belong to one of two categories. The support vector machine may be trained to assign a new input value to one of the two categories. Alternatively, the machine-learning model may be a Bayesian network, which is a probabilistic directed acyclic graphical model. A Bayesian network may represent a set of random variables and their conditional dependencies using a directed acyclic graph. Alternatively, the machine-learning model may be based on a genetic algorithm, which is a search algorithm and heuristic technique that mimics the process of natural selection.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

100, 100a to 100i Hydrogel bead
102, 1308, 1318 Microbead
200 Core
202 Layer
204 Interface
300, 400 Microfluidic device
302, 402 Unpolymerised hydrogel
600, 700 Lithographic device
602, 1108, 1300, 1306, 1310, 1314 Flow cell
604, 1106, 1110 Objective
606 First tank
608 Second tank
702 Tray
800 3D-barcode
900 Photophysically changed areas
902 Negative hydrogel bead
904 Binding site
906 Positive hydrogel bead
908 Dye molecule
910 Dye solution
912 Hydrogel polymer
914 Coupled dye molecule
1100, 1102, 1400 Imaging system
1104 Tray
1105, 1112 Liquid
1302 Fluorescent dye
1304 Focus plane
1312, 1316 Calibration object
1402 Microscope
1404 Computer system

1. A calibration object for calibrating an imaging system, the calibration object comprising:
a discrete entity with a calibration pattern,
wherein the discrete entity is made of at least one transparent polymeric compound.

2. The calibration object according to claim 1, wherein the polymeric compound is a hydrogel.

3. The calibration object according to claim 1, wherein the discrete entity has a spherical or spheroidal shape.

4. The calibration object according to claim 1, wherein the calibration pattern is distributed in the discrete entity inhomogeneously.

5. The calibration object according to claim 1, wherein the discrete entity has a diameter in a range of 50 μm to 250 μm.

6. The calibration object according to claim 1, wherein the discrete entity is in a liquid medium and a refractive index of the polymeric compound is in a range of +/−5% of a refractive index of the liquid medium.

7. The calibration object according to claim 1, wherein the calibration pattern is radially symmetric.

8. The calibration object according to claim 1, wherein the calibration pattern comprises a plurality of concentric spheres.

9. The calibration object according to claim 1, wherein the discrete entity comprises a first section and at least a second section around the first section.

10. The calibration object according to claim 9, wherein the calibration pattern is arranged at least at an interface of the first section and the second section.

11. The calibration object according to claim 1, wherein the calibration pattern comprises a dye.

12. The calibration object according to claim 1, wherein the calibration pattern comprises at least one of a fluorescent microbead, a microbead, a microsphere, a nanoruler or a DNA origami-based nanostructure.

13. A method for calibrating an imaging system by using at least one calibration object according to claim 1, comprising the following steps:
imaging the calibration object with the imaging system to generate imaging data, wherein the calibration pattern of the calibration object has parameters with predetermined values,
determining measured values of the parameters of the calibration pattern from the imaging data of the calibration object,
comparing the measured values to the predetermined values, and
generating image calibration information for the imaging system based on the comparison of the values.

14. The method according to claim 13, wherein the image calibration information is utilised to correct images acquired by the imaging system.

15. The method according to claim 13, wherein the imaging system is an optofluidic imaging system.

16. The method according to claim 13, wherein the imaging system comprises a flow cell.

17. The method according to claim 13, wherein the imaging system comprises a light sheet microscope.

18. The method according to claim 13, wherein the predetermined values are averages for the calibration pattern.

19. The method according to claim 13, wherein the discrete entity comprises a marker and the predetermined values are associated with the marker.

20. The method according to claim 13, wherein the predetermined values are initially determined by imaging the calibration object with a calibration imaging system.

21. The method according to claim 20, wherein the calibration imaging system is a confocal microscope.

22. The method according to claim 13, wherein the image calibration information is utilised to correct images acquired by at least a second imaging system.

23. The method according to claim 13, wherein the image calibration information is utilised to configure an adaptive optical element of the imaging system in order to correct images acquired by the imaging system.

24. The method according to claim 13, wherein at least a second calibration object is imaged with the imaging system or a second imaging system, and the image calibration information is generated based on the imaging data generated for all imaged calibration objects.

25. The method according to claim 13, wherein the steps of comparing the measured values to the predetermined values and/or generating the image calibration information are performed using machine learning, deep learning or artificial intelligence methods.

26. A method for manufacturing a calibration object configured to calibrate an imaging system, the method comprising,
forming a discrete entity of at least one transparent polymeric compound, and
providing a calibration pattern in the discrete entity to form the calibration object.

27. The method according to claim 26, wherein the discrete entity is formed by lithography, microfluidics, emulsification, or electrospraying.

28. The method according to claim 26, wherein the calibration pattern is generated by photolithography.
